(19) United States
(12) Patent Application Publication
(10) Pub. No.: US 2023/0272882 A1
(43) Pub. Date: Aug. 31, 2023

(54) HYDROGEN STORAGE SYSTEM

(71) Applicants: HYUNDAI MOTOR COMPANY, SEOUL (KR); KIA CORPORATION, SEOUL (KR)

(72) Inventor: Young Jin Cho, Gimhae-si (KR)

(21) Appl. No.: 17/868,200

(22) Filed: Jul. 19, 2022

(30) Foreign Application Priority Data
Feb. 28, 2022 (KR) 10-2022-0026077

(51) Int. Cl. F17C 11/00

(52) U.S. Cl. CPC F17C 11/005; F17C 2221/012; F17C 2203/0636

(57) ABSTRACT

A hydrogen storage system includes a storage container configured to accommodate a metal hydride material therein and having an inlet/outlet port through which hydrogen is introduced into or discharged from the storage container, and a partition unit made of a thermally conductive material and configured to divide an internal space of the storage container into a plurality of separated spaces divided independently, thereby ensuring heat transfer efficiency and improving safety and reliability.

### CROSS REFERENCE TO RELATED APPLICATIONS

This application claims priority to and the benefit of Korean Patent Application No. 10-2022-0026077 filed in the Korean Intellectual Property Office on Feb. 28, 2022, the entire contents of which are incorporated herein by reference.

### TECHNICAL FIELD

An embodiment of the present disclosure relates to a hydrogen storage system, and more particularly, to a hydrogen storage system capable of improving structural safety, reliability, and heat transfer efficiency.

### BACKGROUND

Technologies using hydrogen as an energy carrier have been developed in various fields because hydrogen is economical and environmental-friendly, and capable of being regenerated.

The hydrogen may be produced by fossil fuel-based methods such as steam reforming, coal gasification, water electrolysis, biomass gasification, and other thermochemical processes.

Among the methods, the steam reforming is being widely used because the steam reforming is less restricted in raw material and produces a larger amount of hydrogen in comparison with other processes (methods).

The steam reforming may extract hydrogen from a source gas through a process of desulfurizing a source gas (e.g., town gas), a process of reforming the source gas, and a pressure swing adsorption (PSA) process.

Meanwhile, because hydrogen extracted (produced) in the hydrogen production facility has a low pressure, it is difficult to immediately store the hydrogen in a high-pressure storage facility such as a high-pressure tank. Therefore, hydrogen produced in the hydrogen production facility needs to be compressed by a separate compression facility.

Examples of a method of compressing hydrogen include a method of compressing hydrogen in a mechanical manner and a method of compressing hydrogen in a non-mechanical manner.

As one of the compression facilities that compress hydrogen in a non-mechanical manner, there has been proposed in the related art a facility that compresses hydrogen using a metal hydride-based thermochemical compressor.

Unlike a mechanical compressor (e.g., a reciprocating compressor), the thermochemical compressor may compress hydrogen without a separate mechanical component (e.g., a piston configured to reciprocate). Therefore, it is possible to simplify the structure of the compressor and improve a degree of design freedom and spatial utilization.

Meanwhile, a size of the storage container for storing a metal hydride material needs to be increased to increase a storage capacity per unit volume of the thermochemical compressor. However, if the size of the storage container is increased to a certain level or higher, it is difficult to entirely and uniformly distribute the metal hydride material in an internal space of the storage container, which causes a problem of local expansion (abnormal inflation) of a particular site of the storage container at the time of storing hydrogen. For this reason, there is a problem in that the storage container is deformed and damaged.

In particular, in the related art, there is a problem in that the increase in size of the storage container increases a situation in which the powdered metal hydride material is concentrated and agglomerated at a lower end of the storage container (the amount of agglomeration of the metal hydride material increases) as the process of storing and discharging hydrogen is repeatedly performed. For this reason, there is a problem in that a hydrogen storage ability of the thermochemical compressor deteriorates.

In addition, it is necessary to quickly perform the processes of heating and cooling the metal hydride material to shorten the time required for the thermochemical compressor to compress (store) and discharge hydrogen and improve energy efficiency.

However, in the thermochemical compressor in the related art, a cooling or heating line (heat exchange line) configured to penetrate an interior of the storage container and provided in the form of a tube having a small thickness is configured to cool or heat the metal hydride material while being locally in contact with the metal hydride material. For this reason, it is difficult to shorten the time required to cool or heat the metal hydride material because it is difficult to ensure a sufficient heat exchange area (heat exchange efficiency) between the metal hydride material and the cooling or heating line.

Therefore, recently, various studies have been conducted to ensure structural stability and reliability of the storage container and improve efficiency in heating and cooling the metal hydride material, but the study results are still insufficient. Accordingly, there is a need to develop a technology to ensure structural stability and reliability of the storage container and improve efficiency in heating and cooling the metal hydride material.

### SUMMARY

The present disclosure has been made in an effort to provide a hydrogen storage system capable of ensuring structural safety and reliability and improving heat transfer efficiency.

In particular, the present disclosure has been made in an effort to uniformly distribute a metal hydride material in an entire section of a storage container while preventing the metal hydride material from being concentrated in a particular section of the storage container.

The present disclosure has also been made in an effort to ensure a storage capacity per unit volume of a storage container, improve structural rigidity, and minimize deformation of and damage to the storage container.

The present disclosure has also been made in an effort to ensure a sufficient heat exchange (heat transfer) area for a metal hydride material and improve heat exchange efficiency.

The present disclosure has also been made in an effort to shorten the time required to heat and cool the metal hydride material and improve energy efficiency.

The present disclosure has also been made in an effort to supply low-pressure hydrogen to a device (or a facility) that requires a low-pressure hydrogen operation.

The objects to be achieved by the embodiments are not limited to the above-mentioned objects, but also include objects or effects that may be understood from the solutions or embodiments described below.

An exemplary embodiment of the present disclosure provides a hydrogen storage system including: a storage container configured to accommodate a metal hydride material therein and having an inlet and outlet (inlet/outlet) port through which hydrogen is introduced into or discharged from the storage container; and a partition unit made of a thermally conductive material and configured to divide an internal space of the storage container into a plurality of separated spaces divided independently.

This is to ensure structural stability and reliability of the storage container and improve efficiency in heating and cooling the metal hydride material.

That is, in the related art, if the size (e.g., volume) of the storage container is increased to a certain level or higher, it is difficult to entirely and uniformly distribute the metal hydride material in an internal space of the storage container, which causes a problem of local expansion (abnormal inflation) of a particular site of the storage container at the time of storing hydrogen. For this reason, there is a problem in that the storage container is deformed and damaged. In particular, in the related art, there is a problem in that the increase in size of the storage container increases a situation in which the powdered metal hydride material is concentrated and agglomerated at a lower end of the storage container (the amount of agglomeration of the metal hydride material increases) as the process of storing and discharging hydrogen is repeatedly performed. For this reason, there is a problem in that a hydrogen storage ability of the thermochemical compressor deteriorates.

In addition, in the thermochemical compressor in the related art, a cooling or heating line (heat exchange line) configured to penetrate an interior of the storage container and provided in the form of a tube having a small thickness is configured to cool or heat the metal hydride material while being locally in contact with the metal hydride material. For this reason, there is a problem in that it is difficult to shorten the time required to cool or heat the metal hydride material because it is difficult to ensure a sufficient heat exchange area (heat exchange efficiency) between the metal hydride material and the cooling or heating line.

In contrast, according to the embodiment of the present disclosure, the partition unit may divide the internal space of the storage container into the plurality of separated spaces, and the metal hydride material may be distributed and accommodated in the separated spaces. Therefore, it is possible to obtain an advantageous effect of stably maintaining a state in which the metal hydride material is uniformly distributed over the entire section of the storage container without being concentrated in a particular section of the storage container.

Among other things, according to the embodiment of the present disclosure, it is possible to obtain an advantageous effect of stably ensuring the structural safety and reliability of the storage container even though the size of the storage container increases to ensure the storage capacity per unit volume. Therefore, it is possible to obtain an advantageous effect of minimizing deformation of and damage to the storage container.

Furthermore, according to the embodiment of the present disclosure, the partition unit made of a thermally conductive material may be used to cool or heat the metal hydride material. Therefore, it is possible to obtain an advantageous effect of ensuring a sufficient heat exchange (heat transfer) area for the metal hydride material and improving heat exchange efficiency. Therefore, it is possible to obtain an advantageous effect of shortening the time required to heat or cool the metal hydride material and improving energy efficiency.

According to the exemplary embodiment of the present disclosure, the storage container may include a cylinder part, and a cap part configured to cover an end of the cylinder part.

The partition unit may have various structures capable of dividing the internal space of the storage container into the plurality of separated spaces.

In particular, the partition unit may divide the internal space of the storage container into the plurality of separated spaces having volumes corresponding to one another. Since the plurality of separated spaces has volumes corresponding to one another as described above, the uniform amount (volume) of metal hydride material may be uniformly distributed in the separated spaces.

According to the exemplary embodiment of the present disclosure, the partition unit may include first partition members configured to divide the internal space in a longitudinal direction of the storage container, and second partition members configured to surround an inner surface of the storage container, and the first partition member and the second partition member may collectively define the separated space.

In particular, the first partition member may have a cross-section corresponding to the storage container, and the second partition member may be in close contact with the inner surface of the storage container.

The first and second partition members may be made of various thermally conductive materials having thermal conductivity.

According to the exemplary embodiment of the present disclosure, the first and second partition members may be made of copper.

According to the exemplary embodiment of the present disclosure, the first partition member may have a thickness of 2.5 mm or more.

This is based on the fact that if the thickness of the first partition member is less than 2.5 mm, the first partition member cannot sufficiently exhibit intended target thermal conduction efficiency. Since the thickness of the first partition member is 2.5 mm or more, it is possible to obtain an advantageous effect of allowing the first partition member to sufficiently exhibit the target thermal conduction efficiency.

According to the exemplary embodiment of the present disclosure, the hydrogen storage system may include a hydrogen inlet/outlet tube connected to the inlet/outlet port and configured to pass through the plurality of separated spaces, the hydrogen inlet/outlet tube being configured to allow an inflow or outflow of hydrogen and restrict an outflow of the metal hydride material.

According to the embodiment of the present disclosure described above, the hydrogen inlet/outlet tube may pass through the plurality of separated spaces. Therefore, it is possible to allow hydrogen to smoothly and uniformly enter or exit the plurality of separated spaces.

The hydrogen inlet/outlet tube may have various structures capable of passing through the plurality of separated spaces.

According to the exemplary embodiment of the present disclosure, the hydrogen inlet/outlet tube may penetrate the first partition member. For example, the first partition members may each have a through-hole formed to correspond to the hydrogen inlet/outlet tube, and the hydrogen inlet/outlet tube may be disposed to pass through the through-holes.

According to the exemplary embodiment of the present disclosure, the hydrogen inlet/outlet tube may have a straight shape in the longitudinal direction of the storage container, and exposure areas in which the hydrogen inlet/outlet tube is exposed to the plurality of separated spaces may correspond to one another.

Since the hydrogen inlet/outlet tube has a straight shape and the hydrogen inlet/outlet tube is exposed to the separated spaces through the uniform exposure area as described above, the uniform amount of hydrogen may enter or exit the separated spaces, and the efficiency in compressing and discharging hydrogen may be equally implemented in the separated spaces.

According to the exemplary embodiment of the present disclosure, the hydrogen storage system may include a filter member disposed in the inlet/outlet port and configured to filter hydrogen flowing in or out of the inlet/outlet port.

According to the embodiment of the present disclosure described above, the filter member may be disposed in the inlet/outlet port. Therefore, it is possible to obtain an advantageous effect of effectively removing foreign substances contained in hydrogen flowing in or out of the inlet/outlet port (maintaining purity of hydrogen) and inhibiting contamination of the metal hydride material (preventing hydrogen compressing performance from being degraded by contamination of the metal hydride material).

### BRIEF DESCRIPTION OF THE FIGURES

FIG. 1 is a view for explaining a hydrogen storage system according to an embodiment of the present disclosure.

FIG. 2 is a view for explaining a storage container of the hydrogen storage system according to the embodiment of the present disclosure.

FIG. 3 is a view for explaining a partition unit of a hydrogen storage system according to another embodiment of the present disclosure.

FIG. 4 is a view for explaining a hydrogen inlet/outlet tube of the hydrogen storage system according to another embodiment of the present disclosure.

FIG. 5 is a view for explaining a state in which the hydrogen storage system according to the embodiment of the present disclosure stores hydrogen.

FIG. 6 is a view for explaining a state in which the hydrogen storage system according to the embodiment of the present disclosure discharges hydrogen.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

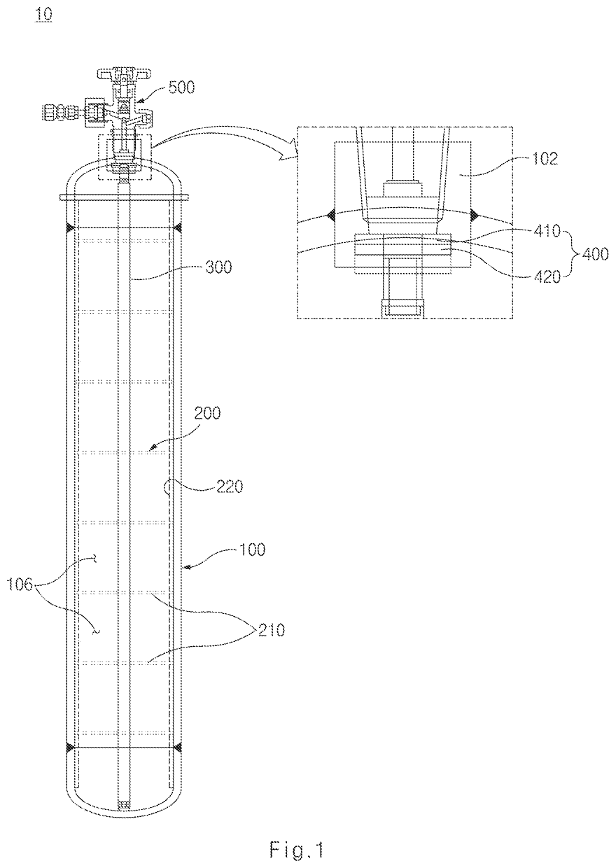

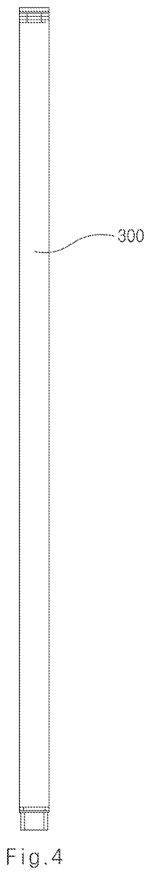

Referring to FIGS. 1 to 6, a hydrogen storage system 10 according to an embodiment of the present disclosure includes a storage container 100 configured to accommodate a metal hydride material therein and having an inlet/outlet port 102 through which hydrogen is introduced into or discharged from the storage container 100, and a partition unit 200 made of a thermally conductive material and configured to divide an internal space 104 of the storage container 100 into a plurality of separated spaces 106 divided independently.

For reference, the hydrogen storage system 10 according to the present disclosure may be used to treat (compress and store) necessary hydrogen. The present disclosure is not restricted or limited by the characteristics and states of hydrogen treated by the hydrogen storage system 10.

For example, the hydrogen storage system 10 according to the embodiment of the present disclosure may be used to compress and store hydrogen produced by a hydrogen production facility before the hydrogen is supplied to a supply destination. According to another embodiment of the present disclosure, the hydrogen storage system according to the present disclosure may also be used to compress again hydrogen that has been compressed once.

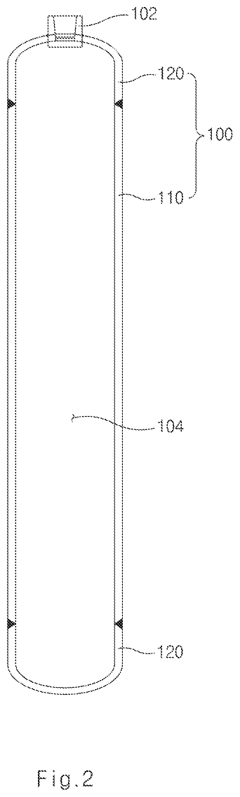

Referring to FIGS. 1 and 2, the storage container 100 may have various structures each having the internal space (storage space) 104 therein. The present disclosure is not restricted or limited by the structure and shape of the storage container 100.

For example, the storage container 100 may include a cylinder part 110, and a cap part 120 configured to cover an end of the cylinder part 110.

The cylinder part 110 may have a hollow cylindrical shape having a circular cross-section. The cap part 120 may have an approximately dome shape. The cap part 120 may be integrally connected to the end of the cylinder part 110 and cover either end (or one end) of the cylinder part 110.

For example, the cap part 120 may be fixed to the end of the cylinder part 110 by welding. Alternatively, the cap part 120 may be fastened to or inserted into the end of the cylinder part 110.

According to another embodiment of the present disclosure, the storage container may have a polygonal (e.g., quadrangular) cross-sectional shape or other cross-sectional shapes.

An inlet and outlet (inlet/outlet) port 102 is disposed at one end (e.g., an upper end based on FIG. 1) of the storage container 100 and allows hydrogen to be introduced into or discharged from the storage container 100.

In this case, the configuration in which hydrogen is introduced into or discharged from the storage container 100 through the inlet/outlet port 102 includes a case in which hydrogen is supplied into the storage container 100 from the outside of the storage container 100 and a case in which hydrogen is discharged from the inside of the storage container 100 to the outside of the storage container 100.

The inlet/outlet port 102 may have various structures through which hydrogen may be introduced or discharged. The present disclosure is not restricted or limited by the structure and shape of the inlet/outlet port 102. For reference, in the embodiment of the present disclosure, the example has been described in which the storage container 100 has only the single inlet/outlet port 102. However, according to another embodiment of the present disclosure, the storage container may have a plurality of inlet/outlet ports. Alternatively, the inlet/outlet port may be provided at a central portion of the storage container instead of the end of the storage container.

In addition, various types of auxiliary devices may be provided in the inlet/outlet port 102 of the storage container 100, and the auxiliary devices may include a valve 500 configured to adjust hydrogen to be introduced into or discharged from the storage container 100, and a safety device (e.g., a rupture disc) (not illustrated) configured to forcibly discharge hydrogen when an internal pressure of the storage container 100 excessively increases. The present disclosure is not restricted or limited by the types and structures of the auxiliary devices.

The storage container 100 accommodates (is filled with) the metal hydride material therein. The metal hydride material may compress hydrogen through repeated heating and cooling processes.

Various materials capable of compressing hydrogen through repeated heating and cooling processes may be used as the metal hydride material. The present disclosure is not restricted or limited by the type and properties of the metal hydride material.

For example, the metal hydride material may include at least any one of lanthanum (La), zirconium (Zr), titanium (Ti), calcium (Ca), and magnesium (Mg) and at least any one of nickel (Ni), copper (Cu), zinc (Zn), iron (Fe), cobalt (Co), manganese (Mn), and vanadium (V). For example, the metal hydride may be any one or more substances selected from LaNi₅, CaCu₅, MgZn₂, ZrNi₂, TiFe, TiCo, Mg₂Ni, TiMn₂, and Mg₂Cu.

For reference, the metal hydride material may be provided in the form of powder or pellets and accommodated in the storage container 100. The present disclosure is not restricted or limited by the accommodated state and shape of the metal hydride material. According to another embodiment of the present disclosure, the metal hydride material may be formed by compressing metal hydride powder or metal hydride pellets and have a bulk shape corresponding to the inner container.

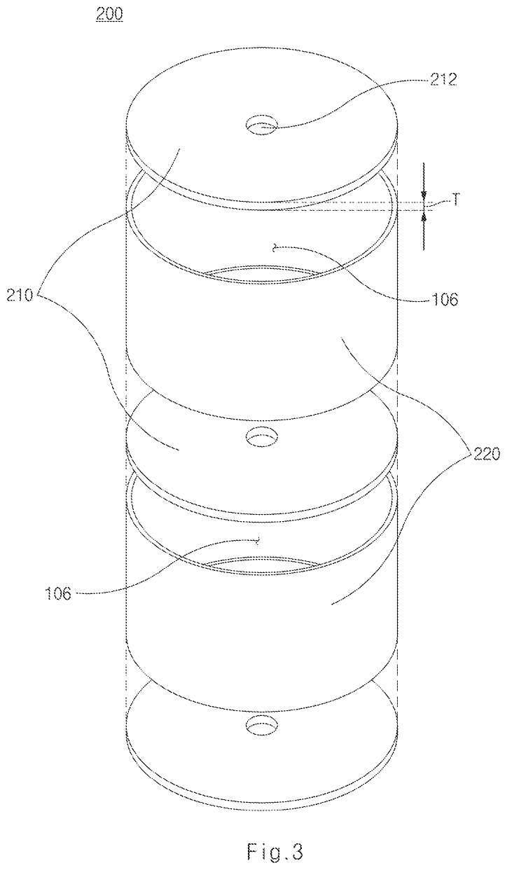

Referring to FIGS. 1 and 3, the partition unit 200 is made of a thermally conductive material and divides the internal space 104 of the storage container 100 into the plurality of separated spaces 106 divided independently.

The partition unit 200 may have various structures capable of dividing the internal space 104 of the storage container 100 into the plurality of separated spaces 106. The present disclosure is not restricted or limited by the structure of the partition unit 200, the number of separated spaces 106, and the shapes of the separated spaces 106.

For example, the partition unit 200 may divide the internal space 104 of the storage container 100 into the plurality of independent separated spaces 106 disposed in a longitudinal direction of the storage container 100 (in an upward/downward direction based on FIG. 1). Alternatively, the partition unit 200 may divide the internal space 104 of the storage container 100 into the plurality of separated spaces 106 disposed in a radial direction of the storage container 100 or other directions.

Hereinafter, an example will be described in which the partition unit 200 divides the internal space 104 of the storage container 100 into nine separated spaces 106. According to another embodiment of the present disclosure, the partition unit may divide the internal space of the storage container into eight or less separated spaces or ten or more separated spaces.

In particular, the partition unit 200 may divide the internal space 104 of the storage container 100 into the plurality of separated spaces 106 having volumes corresponding to one another. Since the plurality of separated spaces 106 has volumes corresponding to one another as described above, the uniform amount (volume) of metal hydride material may be uniformly distributed in the separated spaces 106.

According to the exemplary embodiment of the present disclosure, the partition unit 200 may include a plurality of first partition members 210 configured to divide the internal space 104 in the longitudinal direction of the storage container 100, and a plurality of second partition members 220 configured to surround an inner surface of the storage container 100. The first partition members 210 and the second partition members 220 may collectively define the separated space 106.

In particular, the first partition members 210 may have a cross-section (e.g., a circular cross-section) corresponding to the storage container 100. The second partition members 220 may be in close contact with (adjacent) the inner surface of the storage container 100.

For example, each first partition member 210 may have a circular plate shape having a circular cross-section corresponding to the storage container 100. Each second partition member 220 may have a hollow cylindrical shape having a diameter corresponding to each first partition member 210, such that each second partition member 220 may be in close contact (surface contact) with the inner surface of the storage container 100.

In this case, the configuration in which each second partition member 220 has a hollow cylindrical shape includes a case in which each second partition member 220 has a hollow cylindrical shape having no cut-out line and a case in which each second partition member 220 is formed by winding a plate-shaped member in a hollow cylindrical shape.

The first partition members 210 and the second partition members 220 may be alternately positioned in the longitudinal direction in the storage container 100 and thus divide the internal space 104 of the storage container 100 into the plurality of separated spaces 106.

More specifically, the adjacent first partition members 210 may define a top surface and a bottom surface (based on FIG. 1) of the separated space 106. Each second partition member 220 interposed between the adjacent first partition members 210 may define a lateral surface of the separated space 106.

The first and second partition members 210 and 220 may be made of various thermally conductive materials having thermal conductivity. The present disclosure is not restricted or limited by the type and properties of the thermally conductive material.

For example, the first and second partition members 210 and 220 may be made of copper having excellent thermal conductivity.

According to the embodiment of the present disclosure described above, the partition unit 200 (the first partition member and the second partition member) may be made of a thermally conductive material. Therefore, the partition unit 200 may serve as not only a partition wall for dividing the internal space 104 of the storage container 100 into the plurality of separated spaces 106 but also a heat transfer medium for cooling or heating the metal hydride material.

More specifically, heat or cold energy transferred (conducted) to the partition unit 200 may be transferred to (exchange heat with) the metal hydride material in the longitudinal direction of the storage container 100 by means of the second partition members 220, and simultaneously, transferred to (exchange heat with) the metal hydride material in the radial direction of the storage container 100 by means of the first partition members 210.

Among other things, according to the embodiment of the present disclosure, heat or cold energy may be transferred to the metal hydride material not only in a vertical direction of the metal hydride material (the longitudinal direction of the storage container 100) but also in a horizontal direction of the metal hydride material (the radial direction of the storage container). Therefore, it is possible to obtain an advantageous effect of shortening the time required to cool or heat the metal hydride material and further improving performance in cooling and heating the metal hydride material.

According to the exemplary embodiment of the present disclosure, each first partition member 210 (made of a copper material, for example) has a thickness T of 2.5 mm or more.

This is based on the fact that if the thickness T of each first partition member 210 is less than 2.5 mm, each first partition member 210 cannot sufficiently exhibit intended target thermal conduction efficiency (e.g., can exhibit 15% of the intended target thermal conduction efficiency). Since the thickness T of each first partition member 210 is 2.5 mm or more, it is possible to obtain an advantageous effect of allowing each first partition member 210 to sufficiently exhibit the intended target thermal conduction efficiency.

According to the embodiment of the present disclosure described above, the partition unit 200 may divide the internal space 104 of the storage container 100 into the plurality of separated spaces 106, and the metal hydride material may be distributed and accommodated in the separated spaces 106. Therefore, it is possible to obtain an advantageous effect of stably maintaining a state in which the metal hydride material is uniformly distributed over the entire section of the storage container 100 without being concentrated in a particular section of the storage container 100.

Among other things, according to the embodiment of the present disclosure, it is possible to obtain an advantageous effect of stably ensuring the structural safety and reliability of the storage container 100 even though the size of the storage container 100 increases to ensure the storage capacity per unit volume. Therefore, it is possible to obtain an advantageous effect of minimizing deformation of and damage to the storage container 100.

Furthermore, according to the embodiment of the present disclosure, the partition unit 200 made of a thermally conductive material may be used to cool or heat the metal hydride material. Therefore, it is possible to obtain an advantageous effect of ensuring a sufficient heat exchange (heat transfer) area for the metal hydride material and improving heat exchange efficiency. Therefore, it is possible to obtain an advantageous effect of shortening the time required to heat or cool the metal hydride material, minimizing a temperature deviation of the metal hydride material, heating or cooling the entire metal hydride material at a uniform temperature, and improving energy efficiency.

Meanwhile, the operations of heating and cooling the partition unit 200 (the first partition member and the second partition member) may be implemented in various ways in accordance with required conditions and design specifications.

For example, a heating unit (e.g., a heater) and a cooling unit (e.g., a water-cooled cooling unit) may be provided outside the storage container 100. The partition unit 200 may be heated or cooled by heat or cold energy transferred (conducted) along the storage container 100 as the storage container 100 is heated or cooled by the heating unit or the cooling unit.

Alternatively, the heating unit and the cooling unit may be provided inside the storage container 100 instead of being disposed outside the storage container 100, such that the partition unit 200 may be heated or cooled by the heating unit or the cooling unit.

Referring to FIGS. 1, and 3 to 4, according to the exemplary embodiment of the present disclosure, the hydrogen storage system 10 may include a hydrogen inlet and outlet (inlet/outlet) tube 300 connected to the inlet/outlet port 102 and configured to pass through the plurality of separated spaces 106. The hydrogen inlet/outlet tube 300 may allow the inflow and outflow of hydrogen and restrict an outflow of the metal hydride material.

The hydrogen inlet/outlet tube 300 may be configured to allow hydrogen to smoothly and uniformly enter or exit the plurality of separated spaces 106.

That is, since the hydrogen inlet/outlet tube 300 is connected to the inlet/outlet port 102 while passing through the plurality of separated spaces 106, hydrogen may be uniformly introduced into and discharged from not only the separated space 106 closest to the inlet/outlet port 102 (e.g., the separated space positioned at an uppermost end of the storage container based on FIG. 1) but also the separated space 106 farthest from the inlet/outlet port 102 (e.g., the separated space positioned at a lowermost end of the storage container based on FIG. 1).

The hydrogen inlet/outlet tube 300 may have various structures and be made of various materials so that the hydrogen inlet/outlet tube 300 may restrict (prevent) the outflow of the metal hydride material while allowing hydrogen to enter or exit the plurality of separated spaces 106. The present disclosure is not restricted or limited by the structure and material of the hydrogen inlet/outlet tube 300.

For example, the hydrogen inlet/outlet tube 300 may be configured as a porous member having pores (or holes) smaller in size than particles of the metal hydride material.

The hydrogen inlet/outlet tube 300 may have various structures capable of passing through the plurality of separated spaces 106.

In this case, the configuration in which the hydrogen inlet/outlet tube 300 passes through the separated spaces 106 means that the hydrogen inlet/outlet tube 300 is at least partially exposed to the separated spaces 106.

For example, the hydrogen inlet/outlet tube 300 may penetrate the first partition members 210. For example, a through-hole 212 corresponding to the hydrogen inlet/outlet tube 300 (e.g., having a diameter corresponding to the hydrogen inlet/outlet tube) may be formed in a central portion of each of the first partition members 210, and the hydrogen inlet/outlet tube 300 may be disposed to pass through the through-holes 212.

According to the exemplary embodiment of the present disclosure, the hydrogen inlet/outlet tube 300 may have a straight shape in the longitudinal direction of the storage container 100 (in the upward/downward direction based on FIG. 1), and exposure areas in which the hydrogen inlet/outlet tube 300 is exposed to the plurality of separated spaces 106 may correspond to one another.

Since the hydrogen inlet/outlet tube 300 has a straight shape and the hydrogen inlet/outlet tube 300 is exposed to the separated spaces 106 through the uniform exposure area as described above, the uniform amount of hydrogen may enter or exit the separated spaces 106, and the efficiency in compressing and discharging hydrogen may be equally implemented in the separated spaces 106.

In the embodiment of the present disclosure illustrated and described above, the example has been described in which the hydrogen inlet/outlet tube 300 has a straight shape. However, according to another embodiment of the present disclosure, the hydrogen inlet/outlet tube may have a curved shape (e.g., a zigzag shape) or other shapes. Alternatively, the exposure areas of the hydrogen inlet/outlet tube may be different from one another for the respective separated spaces.

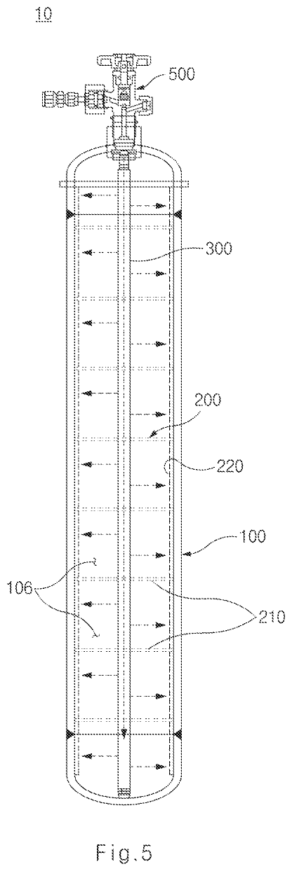

Referring to FIGS. 1 and 5, at the time of storing hydrogen, hydrogen supplied through the inlet/outlet port 102 may be individually stored in each of the separated spaces 106 while moving along the hydrogen inlet/outlet tube 300.

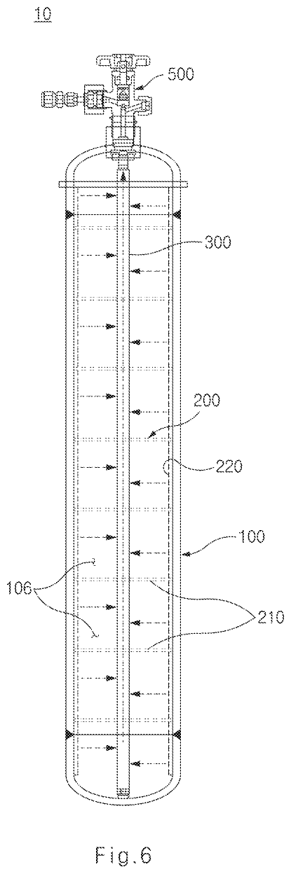

In contrast, referring to FIGS. 1 and 6, at the time of discharging hydrogen, hydrogen treated (compressed) in each of the separated spaces 106 may move along the hydrogen inlet/outlet tube 300 and then be discharged to the outside (e.g., a fuel cell stack) through the inlet/outlet port 102. In this case, the metal hydride material accommodated in each of the separated spaces 106 cannot pass through the hydrogen inlet/outlet tube 300. Therefore, the metal hydride material may be kept remaining in each of the separated spaces 106.

According to the exemplary embodiment of the present disclosure, the hydrogen storage system 10 may include a filter member 400 disposed in the inlet/outlet port 102 and configured to filter hydrogen flowing in or out of the inlet/outlet port 102.

Various filters capable of filtering out foreign substances (e.g., contaminants and moisture) contained in hydrogen flowing in or out of the inlet/outlet port 102 may be used as the filter member 400. The present disclosure is not restricted or limited by the type and structure of the filter member 400.

For example, the filter member 400 may include a first filter 410, and a second filter 420 stacked on the first filter 410. Hereinafter, an example will be described in which the first and second filters 410 and 420 may be made of the same material. According to another embodiment of the present disclosure, the first and second filters may be made of different materials. Alternatively, the filter member may include a single filter.

According to the embodiment of the present disclosure described above, the filter member 400 may be disposed in the inlet/outlet port 102. Therefore, it is possible to obtain an advantageous effect of effectively removing foreign substances contained in hydrogen flowing in or out of the inlet/outlet port 102 (maintaining purity of hydrogen) and inhibiting contamination of the metal hydride material (preventing hydrogen compressing performance from being degraded by contamination of the metal hydride material).

According to the embodiment of the present disclosure described above, it is possible to obtain an advantageous effect of ensuring structural safety and reliability and improving heat transfer efficiency.

In particular, according to the embodiment of the present disclosure, it is possible to obtain an advantageous effect of stably maintaining the state in which the metal hydride material is uniformly distributed over the entire section of the storage container without being concentrated in a particular section of the storage container.

In addition, according to the embodiment of the present disclosure, it is possible to obtain an advantageous effect of ensuring the storage capacity per unit volume of the storage container, improving structural rigidity, and minimizing deformation of and damage to the storage container.

In addition, according to the embodiment of the present disclosure, it is possible to obtain an advantageous effect of ensuring the sufficient heat exchange (heat transfer) area for the metal hydride material and improving heat exchange efficiency.

In addition, according to the embodiment of the present disclosure, it is possible to obtain an advantageous effect of shortening the time required to heat or cool the metal hydride material and improving energy efficiency.

In addition, according to the embodiment of the present disclosure, it is possible to stably supply low-pressure hydrogen to the device (or the facility) that requires the low-pressure hydrogen operation.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

1. A hydrogen storage system comprising:
a storage container configured to accommodate a metal hydride material, the storage container having an inlet and outlet port through which hydrogen is introduced into or discharged from the storage container; and
a partition unit made of a thermally conductive material, the partition unit being configured to divide an internal space of the storage container into a plurality of separately divided spaces.

2. The hydrogen storage system of claim 1, wherein the partition unit comprises:
a plurality of first partition members configured to divide the internal space in a longitudinal direction of the storage container; and
a plurality of second partition members configured to surround an inner surface of the storage container, wherein the plurality of first partition members and the plurality of second partition members define the separated space.

3. The hydrogen storage system of claim 2, wherein each of the plurality of first partition members has a cross-section corresponding to the storage container, and each of the plurality of second partition members is in contact with the inner surface of the storage container.

4. The hydrogen storage system of claim 2, wherein each of the plurality of first partition members has a thickness of 2.5 mm or more.

5. The hydrogen storage system of claim 2, wherein each of the plurality of first and second partition members are made of copper.

6. The hydrogen storage system of claim 1, wherein the partition unit divides the internal space into the plurality of separated spaces having volumes corresponding to one another.

7. The hydrogen storage system of claim 2, comprising:
a hydrogen inlet and outlet tube connected to the inlet and outlet port, and configured to pass through the plurality of separated spaces, the hydrogen inlet and outlet tube being configured to allow an inflow or outflow of hydrogen and restrict an outflow of the metal hydride material.

8. The hydrogen storage system of claim 7, wherein the hydrogen inlet and outlet tube penetrates each of the plurality of first partition members.

9. The hydrogen storage system of claim 8, wherein each of the plurality of first partition members has a through-hole corresponding to the hydrogen inlet and outlet tube, and the hydrogen inlet and outlet tube passes through the through-holes.

10. The hydrogen storage system of claim 7, wherein the hydrogen inlet and outlet tube has a straight shape in the longitudinal direction of the storage container, and exposure areas in which the hydrogen inlet and outlet tube is exposed to the plurality of separated spaces correspond to one another.

11. The hydrogen storage system of claim 1, comprising:
a filter member positioned in the inlet and outlet port and configured to filter hydrogen flowing in or out of the inlet and outlet port.

12. The hydrogen storage system of claim 1, wherein the storage container comprises:
a cylinder part; and
a cap part configured to cover an end of the cylinder part.
